(19) United States
(12) Patent Application Publication
(10) Pub. No.: US 2007/0167565 A1
(43) Pub. Date: Jul. 19, 2007

(54) Polyurethane-polyurea dispersions based on polyether-polycarbonate-polyols

(76) Inventors: Thorsten Rische, Unna (DE); Thomas Feller, Solingen (DE); Holger Casselmann, Odenthal (DE); Gerald Kurek, Leipzig (DE); Steffen Hofacker, Odenthal (DE)

Correspondence Address: BAYER MATERIAL SCIENCE LLC, 100 BAYER ROAD, PITTSBURGH, PA, 15205, US

(21) Appl. No.: 11/651,773

(22) Filed: Jan. 10, 2007

(30) Foreign Application Priority Data
Jan. 17, 2006 (DE) 102006002156.8

(51) Int. Cl. C08G 18/08

(52) U.S. Cl. 524/589

(57) ABSTRACT

The invention relates to new, hydrolysis-stable, aqueous polyurethane-polyurea dispersions based on polyether-polycarbonate-polyols, to a process for preparing them and to their use in coating materials.

### CROSS-REFERENCE TO RELATED APPLICATIONS

The present application claims the right of priority under 35 U.S.C. §119 (a)-(d) of German Patent Application Number 10 2006 002156, filed Jan. 17, 2006.

### BACKGROUND OF THE INVENTION

The invention relates to new, hydrolysis-stable, aqueous polyurethane-polyurea dispersions based on polyether-polycarbonate-polyols, to a process for preparing them and to their use in coating materials.

Substrates are increasingly being coated using aqueous binders, especially polyurethane-polyurea (PU) dispersions. The preparation of aqueous PU dispersions is known to those skilled in the art.

In contrast to many other classes of aqueous binders, PU dispersions are notable in particular for high resistance to chemicals and water, high mechanical robustness, and a high tensile strength and stretchability. These requirements are largely met by traditional polyurethane-polyurea dispersions. Suitable dispersions may, as a result of hydrophilic groups, be self-emulsifying—that is, they may be dispersed in water without the aid of external emulsifiers. A disadvantage of those PU dispersions is that they do not always satisfy the heightened requirements, regarding extremely high tensile strength in conjunction with very high stretchability even under hydrolysis conditions.

Hydroxyl-containing, polytetramethylene glycol-based polycarbonates are obtainable in principle through reaction of phosgene (e.g. DE-A 1 595 446), bischlorocarbonic esters (e.g. DE-A 857 948), diaryl carbonates (e.g. DE-A 1 012 557), cyclic carbonates (e.g. DE-A 2 523 352) or dialkyl carbonates (e.g. WO-A 2003/2630) with aliphatic polyols.

It is likewise possible to prepare polyether-polycarbonates by transesterifying diemthyl carbonate with aliphatic polyols, as described for example in EP-A 1 404 740, EP-A 1 520 869, EP-A 1 518 879 and EP-A 1 477 508. The use of such building blocks in aqueous polyurethane dispersions is likewise known.

From DE-A 101 22 444 it is known that coatings comprising ionically and/or nonionically hydrophilicized, aqueous PU dispersions based on polycarbonate polyols and polytetramethylene glycol polyols possess excellent hydrolysis stabilities in conjunction with generally good tensile and stretch properties.

The object of the present invention, then, was to provide PU dispersions which in relation to the prior art possess significantly improved mechanical properties in respect of high tensile strength in conjunction with high stretchability and which, furthermore, exhibit very good hydrolysis stability.

It has now been found that aqueous PU dispersions which comprise a defined amount of polytetramethylene glycol-based polycarbonate polyols yield coatings which fulfill the above-required improvements in terms of the stated mechanical properties.

### SUMMARY OF THE INVENTION

The present invention accordingly provides aqueous polyurethane-polyurea dispersions comprising the synthesis components:
I.1) one or more polyisocyanates,
I.2) one or more polymeric polyols having number-average molecular weights of 400 to 8000 g/mol, having a hydroxyl number of 22 to 400 mg KOH/g, and an OH functionality of 1.5 to 6,
I.3) one or more compounds having a molecular weight of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds, and
I.6) optionally one or more isocyanate-reactive, nonionically hydrophilicizing compounds,
   wherein the polyol component I.2) contains 60% to 100% by weight of polytetramethylene glycol-based polycarbonate polyols, based on the total amount of component I.2).

The present invention also provides a process for preparing the aqueous polyurethane-polyurea dispersions of the invention, comprising
a) reacting:
   I.1) one or more polyisocyanates,
   I.2) one or more polymeric polyols having number-average molecular weights of 400 to 8000 g/mol, having a hydroxyl number of 22 to 400 mg KOH/g, and an OH functionality of 1.5 to 6,
   I.3) one or more compounds having a molecular weight of 62 to 400 g/mol and possessing in total two or more hydroxyl and/or amino groups,
   I.4) optionally one or more compounds possessing a hydroxyl or amino group,
   I.5) one or more isocyanate-reactive, ionically or potentially ionically hydrophilicizing compounds, and
   I.6) optionally one or more isocyanate-reactive, nonionically hydrophilicizing compounds
      such that an isocyanate-functional prepolymer free of urea groups is prepared, the molar ratio of isocyanate groups to isocyanate-reactive groups being 1.0 to 3.5
b) dispersing the reaction products in water; and
c) before, during or after dispersing in water, subjecting the remaining isocyanate groups to amino-functional chain extension or chain termination, wherein the equivalent ratio of isocyanate-reactive groups of the compounds used for chain extension to free isocyanates groups of the prepolymer is between 40% to 150%.

### DETAILED DESCRIPTION OF THE PREFERRED EMBODIMENTS

Unless otherwise indicated, all references in the specification and the claims to “molecular weight” are to number-average molecular weight.

Suitable polyisocyanates of component I.1) are the aromatic, araliphatic, aliphatic or cycloaliphatic polyisocyanates which are known in the art. They can be used individually or in any desired mixtures with one another.

Examples of suitable polyisocyanates are butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)-methanes or their mixtures with any desired isomer content, cyclohexylene 1,4-diisocyanate, phenylene 1,4-diisocyanate, tolylene 2,4-and/or 2,6-diisocyanate, naphthylene 1,5-diisocyanate, diphenylmethane 2,4′- or 4,4′-diisocyanate, 1,3- and 1,4-bis(2-isocyanatoprop-2-yl)benzene (TMXDI) and 1,3-bis(isocyanatomethyl)benzene (XDI). Proportionally it is also possible to use polyisocyanates having a functionality≦2. These include modified diisocyanates with a uretdione, isocyanurate, urethane, allophanate, biuret, iminooxadiazinedione and/or oxadiazinetrione structure, and also unmodified polyisocyanate having more than 2 NCO groups per molecule, for example 4-isocyanatomethyloctane 1,8-diisocyanate (nonane triisocyanate) or triphenylmethane 4,4′,4″-triisocyanate.

The polyisocyanates or polyisocyanate mixtures in question are preferably those of the aforementioned kind containing exclusively aliphatically and/or cycloaliphatically attached isocyanate groups, with an average functionality of 2 to 4, preferably 2 to 2.6 and more preferably 2 to 2.4.

Particular preference is given to hexamethylene diisocyanate, isophorone diisocyanate, the isomeric bis(4,4′-isocyanatocyclohexyl)methanes, and mixtures thereof.

It is essential to the invention that the polyol component I.2) contains 60% to 100% by weight, preferably 65% to 100% by weight and more preferably 75% to 100% by weight of polytetramethylene glycol-based polycarbonate polyols, based on the total amount of component I.2).

Suitable polytetramethylene glycol-based polycarbonate polyols having a molecular weight Mn of 400 to 8000 g/mol and an OH functionality of 1.5 to 4.0, preferably a molecular weight of 600 to 3000 g/mol and an OH functionality of 1.8 to 3.0 and more preferably a molecular weight of 900 to 3000 g/mol and an OH functionality of 1.9 to 2.2. They are prepared in accordance with EP-A 1 404 740 (pp. 6-8, Examples 1-6) or as per EP-A 1 477 508 (p. 5, Example 3).

Suitable aliphatic diols and polyols for preparing the polytetramethylene glycol-based polycarbonate polyols are the polytetramethylene glycol polyether polyols which are known per se in polyurethane chemistry and can be prepared, for example, via polymerization of tetrahydrofuran by cationic ring opening. Polytetramethylene glycol polyether polyols of this kind have a number-average molecular weight of 250 to 8000 g/mol and an OH functionality of 1.5 to 4, preferably a number-average molecular weight of 250 to 3000 g/mol and an OH functionality of 1.8 to 3.0, and with particular preference a number-average molecular weight of 250 to 1000 g/mol and an OH functionality of 1.9 to 2.2. Very particular preference is given to polytetramethylene glycol polyether polyols having a number-average molecular weight of 250 to 650 g/mol and an OH functionality of 1.9 to 2.1.

Further suitable polyols I.2) are the organic polyhydroxyl compounds which are known in polyurethane coating technology, such as, for example, the typical polyester polyols, polyacrylate polyols, polyurethane polyols, polycarbonate polyols, polyether polyols or hybrid forms thereof. Preference is given to using polyether polyols in a mixture with the polytetramethylene glycol-based polycarbonate polyols.

Suitable polyether polyols are, for example, the polyaddition products of the styrene oxides, of ethylene oxide, propylene oxide, tetrahydrofuran, butylene oxide, epichlorohydrin, and also their mixed addition products and grafting products, and also the polyether polyols obtained by condensing polyhydric alcohols or mixtures thereof and those obtained by alkoxylating polyhydric alcohols, amines and amino alcohols. Preference is given to polytetramethylene glycol polyether polyols having a number-average molecular weight of 600 to 3000 g/mol and an OH functionality of 1.9 to 2.2, which are used in a mixture with the polytetramethylene glycol-based polycarbonate polyols.

The low molecular weight polyols I.3) used for synthesizing the polyurethane resins generally have the effect of stiffening and/or of branching the polymer chain. The molecular weight is preferably between 62 and 299 g/mol. Suitable polyols I.3) may contain aliphatic, alicyclic or aromatic groups. Mention may be made here, by way of example, of the low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), and also trimethylolpropane, glycerol or pentaerythritol, and mixtures of these and optionally also further low molecular weight polyols I.3). Esterdiols as well, such as α-hydroxybutyl-ε-hydroxycaproic esters, ω-hydroxyhexyl-γ-hydroxybutyric esters, adipic acid β-hydroxyethyl esters or terephthalic acid bis(β-hydroxyethyl) esters, can be used. Preferred synthesis components ii) are 1,2-ethanediol, 1,4-butanediol, 1,6-hexanediol and 2,2-dimethylpropane-1,3-diol. Particular preference is given to 1,4-butanediol and 1,6-hexanediol.

Diamines or polyamines and also hydrazides can likewise be used as I.3), examples being ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic dihydrazide.

Also suitable in principle as I.3) are compounds which contain active hydrogen having different reactivity towards NCO groups, such as compounds which contain both a primary amino group and secondary amino groups or as well as an amino group (primary or secondary) also contain OH groups. Examples of such are primary/secondary amines, such as 3-amino-1-methylaminopropane, 3-amino-1-ethylaminopropane, 3-amino-1-cyclohexylaminopropane, 3-amino-1-methylaminobutane, and also alkanolamines such.as N-aminoethylethanolamine, ethanolamine, 3-aminopropanol, neopentanolamine and, with particular preference, diethanolamine. In the preparation of the PU dispersion of the invention they can be used as chain extenders and/or as chain termination.

The PU dispersions of the invention may also optionally contain units I.4) which are in each case located at the chain ends and close off the ends. These units are derived from monofunctional compounds reactive with NCO groups, such as monoamines, especially mono-secondary amines, or monoalcohols. Mention may be made here, by way of example, of ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)amino-propylamine, morpholine, piperidine, and/or suitable substituted derivatives thereof, amide amines formed from diprimary amines and monocarboxylic acids, monoketimes of diprimary amines, primary/tertiary amines, such as N,N-dimethyl-aminopropylamine, and the like.

By ionically or potentially ionically hydrophilicizing compounds I.5) are meant all compounds which contain at least one isocyanate-reactive group and also at least one functionality, such as —COOY, —SO₃Y, —PO(OY)₂ (Y, for example, ═H, NH₄⁺, metal cation), —NR2, —NR₃+(R═H, alkyl, aryl), which on interaction with aqueous media, enters into a pH-dependent dissociation equilibrium and in that way may carry a negative, positive or neutral charge. Preferred isocyanate-reactive groups are hydroxyl or amino groups.

Suitable ionically or potentially ionically hydrophilicizing compounds corresponding to the definition of component I.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylenediamine-propyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and also compounds which contain units which can be converted into cationic groups, examples being amine-based units, such as N-methyldiethanolamine, as hydrophilic synthesis components. It is additionally possible to use cyclohexylaminopropanesulphonic acid (CAPS) as, for example, in WO-A 01/88006 as a compound corresponding to the definition of component I.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Suitable nonionically hydrophilicizing compounds corresponding to the definition of component I.6) are, for example, polyoxyalkylene ethers which contain at least one hydroxyl or amino group. These polyethers contain a fraction of 30% to 100% by weight of units derived from ethylene oxide.

Hydrophilic synthesis components I.6) for incorporating terminal hydrophilic chains containing ethylene oxide units are preferably compounds of the formula (1),
H—Y′—X—Y—R (I)
in which
R is a monovalent hydrocarbon radical having 1 to 12 carbon atoms, preferably an unsubstituted alkyl radical having 1 to 4 carbon atoms,
X is a polyalkylene oxide chain having 5 to 90, preferably 20 to 70 chain members, which may be composed to an extent of at least 40%, preferably at least 65%, of ethylene oxide units and which in addition to ethylene oxide units may be composed of propylene oxide, butylene oxide or styrene oxide units, preference among the last-mentioned units being given to propylene oxide units, and
Y/Y′ is oxygen or else is —NR′—. with R′ corresponding in its definition to R or hydrogen.

Particularly preferred synthesis components I.6) are the copolymers of ethylene oxide with propylene oxide, having an ethylene oxide mass fraction of greater than 50%, more preferably of 55% to 89%.

In one preferred embodiment use is made as synthesis components I.6) of compounds having a molecular weight of at least 400 g/mol, preferably of at least 500 g/mol and more preferably of 1200 to 4500 g/mol.

Preference is given to using 5% to 40% by weight of component I.1), 60% to 90% by weight of the sum of components I.2), 0.5 to 20% by weight of the sum of compounds I.3) and I.4), 0.1% to 5% by weight of component I.5), 0% to 20% by weight of component I.6), the sum of I.5) and I.6) being 0.1% to 25% by weight and the sum of all the components adding up to 100% by weight.

Particular preference is given to using 5% to 35% by weight of component I.1), 65% to 85% by weight of the sum of components I.2), 0.5 to 15% by weight of the sum of compounds I.3) and I.4). 0.1% to 4% by weight of component I.5), 0% to 15% by weight of component I.6), the sum of I.5) and I.6) being 0.1% to 19% by weight and the sum of all the components adding up to 100% by weight.

Very particular preference is given to using 10% to 30% by weight of component I.1), 65% to 80% by weight of the sum of components I.2), 0.5 to 14% by weight of the sum of compounds I.3) and I.4), 0.1% to 3.5% by weight of component I.5), 0% to 10% by weight of component I.6), the sum of I.5) and I.6) being 0.1% to 13.5% by weight and the sum of all the components adding up to 100% by weight.

The process for preparing the aqueous PU dispersion (I) can be carried out in one or more stages in a homogeneous phase or, in the case of multi-stage reaction, partially in disperse phase. Following polyaddition of I.1)-I.6), carried out completely or partially, there are dispersing, emulsifying or dissolving steps. Thereafter, optionally, there is a further polyaddition or modification in disperse phase.

To prepare the aqueous PU dispersions of the invention it is possible to use all of the methods known in the art, such as the prepolymer mixing method, acetone method or melt dispersing method, for example. The PU dispersions of the invention are prepared preferably by the acetone method.

For preparing the PU dispersion (I) by the acetone method, the constituents I.2) to I.6), which should contain no primary or secondary amino groups, and the polyisocyanate component I.1) for preparing an isocyanate-functional polyurethane prepolymer, are usually introduced as an initial charge, in whole or in part, diluted optionally with a solvent which is miscible with water but inert towards isocyanate groups, and heated to temperatures in the range from 50 to 120° C. To accelerate the isocyanate addition reaction it is possible to use the catalysts that are known in polyurethane chemistry. Preference is given to dibutyltin dilaurate.

Suitable solvents are the customary aliphatic, keto-functional solvents such as acetone or butanone, for example, which can be added not only at the beginning of the preparation but also, optionally, in portions later on. Acetone and butanone are preferred. Other solvents such as, for example, xylene, toluene, cyclohexane, butyl acetate, methoxypropyl acetate, N-methylpyrolidene solvents with ether units or ester units, may likewise be employed and distilled off in whole or in part, or may remain completely in the dispersion.

Subsequently any constituents from I.1)-I.6) that were not added at the beginning of the reaction are metered in.

With regard to the preparation of the polyurethane prepolymer, the molar ratio of isocyanate groups to isocyanate-reactive groups is I.0 to 3.5, preferably 1.2 to 3.0, more preferably 1.3 to 2.5.

The reaction of components I.1)-I.6) to form the prepolymer takes place partially or completely, but preferably completely. In this way polyurethane prepolymers containing free isocyanate groups are obtained, in bulk (without solvent) or in solution.

The preparation of the polyurethane prepolymers is accompanied or followed, if it has not yet been carried out in the starting molecules, by the partial or complete formation of salts of the anionically and/or cationically dispersing groups.

In the case of anionic groups, use is made for this purpose of bases such as tertiary amines, examples being trialkylamines having 1 to 12, preferably 1 to 6, C atoms in each alkyl radical. Examples thereof are trimethylamine, triethylamine, methyldiethylamine, tripropylamine, N-methylmorpholine, methyldiisopropylamine, ethyldiisopropylamine and diisopropylethylamine. The alkyl radicals may also, for example, bear hydroxyl groups, as in the case of the dialkylmonoalkanolamines, alkyldialkanolamines and trialkanolamines. As neutralizing agents it is also possible optionally to use inorganic bases, such as ammonia or sodium hydroxide and/or potassium hydroxide. Preference is given to triethylarnine, triethanolamine, dimethylethanolamine or diisopropylethylamine.

The molar amount of the bases is between 50% and 125%, preferably between 70% and 100%, of the molar amount of the anionic groups.

In the case of cationic groups, dimethyl sulphate or succinic acid or phosphoric acid are used. Neutralization may also take place simultaneously with dispersing, with the dispersing water already containing the neutralizing agent.

Subsequently, in a further process step, if it has not yet happened or has taken place only partially, the prepolymer obtained is dissolved using aliphatic ketones such as acetone or butanone.

Subsequently, possible NH₂-functional and/or NH-functional components are reacted with the remaining isocyanate groups. This chain extension/chain termination may be carried out either in solvent prior to dispersing, during dispersing, or in water after dispersing. Chain extension is preferably carried out prior to dispersing in water.

Where chain extension is carried out using compounds corresponding to the definition of I.5) with NH₂ groups or NH groups, the prepolymers are preferably chain-extended before the dispersing operation.

The degree of chain extension, in other words the equivalent ratio of NCO-reactive groups of the compounds used for chain extension to free NCO groups of the prepolymer, is between 40% to 150%, preferably between 50% to 120%, more preferably between 60% to 120%.

The aminic components [I.3), I.4), I.5)] may optionally be used in water- or solvent-diluted form in the process of the invention, individually or in mixtures, with any sequence of addition being possible.

If water or organic solvents are used as diluents, the diluent content is preferably 70% to 95% by weight.

The preparation of the PU dispersion from the prepolymers takes place following chain extension. For that purpose the dissolved and chain-extended polyurethane polymer either is introduced into the dispersing water with strong shearing, such as vigorous stirring, for example, or, conversely, the dispersing water is stirred into the prepolymer solutions. Preferably the water is introduced into the dissolved prepolymer.

The solvent still present in the dispersions after the dispersing step is usually subsequently removed by distillation. Its removal during dispersing is also a possibility.

The solids content of the PU dispersion is between 20% to 70%, preferably 30% to 65% by weight.

The PU dispersions of the invention may comprise antioxidants and/or light stabilizers and/or other auxiliaries and additives such as, for example, emulsifiers, defoamers, thickeners. Finally it is also possible for fillers, plasticizers, pigments, carbon-black sols and silica sols, aluminium dispersions, clay dispersions and asbestos dispersions, flow control agents or thixotropic agents to be present. Depending on the desired pattern of properties and intended use of the PU dispersions of the invention it is possible for up to 70%, based on total dry-matter content, of such fillers to be present in the end product.

The present invention also provides coating materials comprising the polyurethane-polyurea dispersions of the invention.

Further provided by the present invention is the use of the polyurethane-polyurea dispersions of the invention as coating materials for producing coated substrates.

The polyurethane-polyurea dispersions of the invention are likewise suitable for producing size systems or adhesive systems.

Examples of suitable substrates include woven and non-woven textiles, leather, paper, hard fiber, straw, paper-like materials, wood, glass, plastics of any of a very wide variety of kinds, ceramic, stone, concrete, bitumen, porcelain, metals or glass fibres or carbon fibres. Preferred substrates are, in particular, flexible substrates such as textiles, leather, plastics, metallic substrates and glass fibres or carbon fibres, and particular preference is given to textiles and leather.

The present invention also provides substrates coated with coating materials comprising the polyurethane-polyurea dispersions of the invention.

The PU dispersions of the invention are stable, storable and transportable and can be processed at any desired subsequent point in time. They can be cured at relatively low temperatures of 120 to 150° C. within 2 to 3 minutes to give coatings which have, in particular, very good wet bond strengths.

On account of their excellent stretchability in conjunction with extremely high tensile strengths, the PU dispersions of the invention are particularly suitable for applications in the field of textile coating and leather coating even under hydrolysis conditions.

### EXAMPLES

Unless indicated otherwise, all percentages are to be understood as being percent by weight.

Substances and Abbreviations Used:

| | |
|---|---|
| PTHF-PC: | polytetramethylene glycol-based polycarbonate |
| Diamino- | NH₂—CH₂CH₂—NH—CH₂CH₂—SO₃Na |
| sulphonate: | (45% in water) |
| Desmophen ® | polycarbonate polyol, OH number 56 mg KOH/g, |
| 2020/ | number-average molecular weight 2000 g/mol |
| Desmophen ® | (Bayer AG, Leverkusen, DE) |
| C2200: | |
| PolyTHF ® | polytetramethylene glycol polyol, OH number 56 mg |
| 2000: | KOH/g, number-average molecular weight |
| | 2000 g/mol (BASF AG, Ludwigshafen, DE) |
| PolyTHF ® | polytetramethylene glycol polyol, OH number |
| 1000: | 112 mg |
| | KOH/g, number-average molecular weight |
| | 1000 g/mol (BASF AG, Ludwigshafen, DE) |
| Polyether | monofunctional polyether based on ethylene |
| LB 25: | oxide/propylene oxide, number-average molecular |
| | weight 2250 g/mol, OH number 25 mg KOH/g |
| | (Bayer AG, Leverkusen, DE) |

The solids contents were determined in accordance with DIN-EN ISO 3251. NCO contents, unless expressly mentioned otherwise, were determined volumetrically in accordance with DIN EN ISO 11909.

### Example 1

Preparation of a polycarbonate polyol having a number-average molecular weight of approximately 2000 g/mol, based on polytetrahydrofuran 250

A 1 liter three-necked flask with stirrer and reflux condenser was charged under nitrogen atmosphere with 1867.1 g (6.11 mol) of polytetrahydrofuran having a number-average molecular weight of 250 g/mol (PolyTHF® 250, BASF AG, Germany) and this initial charge was dewatered at 110° C. and a pressure of 20 mbar for 2 h. Thereafter the charge was blanketed with nitrogen, 0.4 g of titanium tetraisopropoxide and 690.0 g of dimethyl carbonate were added and the reaction mixture was held under reflux (110° C. oil bath temperature) for 24 h. After that the reflux condenser was swapped for a Claisen bridge and the methanol cleavage product formed was removed by distillation along with any dimethyl carbonate still present. For that purpose the temperature was raised from 110° C. to 150° C. over the course of 2 h, and was then maintained for 4 h. After that the temperature was increased to 180° C. over the course of 2 h and then maintained for a further 4 h. Thereafter the reaction mixture was cooled to 100° C. and a stream of nitrogen (2 l/h) was introduced into the reaction mixture. In addition the pressure was lowered gradually to 20 mbar, so that the overhead temperature during the ongoing distillation did not exceed 60° C. After the 20 mbar had been reached, the temperature was raised to 130° C. and held there for 6 h. Aeration and cooling gave an polycarbonate polyol which is liquid at room temperature and has the following characteristics:

| | | |
|---|---|---|
| Hydroxyl number (OHN): | 57.6 | mg KOH/g |
| Viscosity at 23° C., D: 16: | 7000 | mPas |
| Number-average molecular weight (Mₙ): | 1945 | g/mol |

### Example 2

Preparation of a polycarbonate polyol having a number-average molecular weight of approximately 2000 g/mol, based on polytetrahydrofuran 650

Same procedure as in Example 1 with the difference that 584.6 g of polytetrahydrofuran having a number-average molecular weight of 650 g/mol (PolyTHF® 650, BASF AG, Germany) and 79.9 g of dimethyl carbonate, and also 0.12 g of ytterbium acetylacetonate, were used as reactants and as catalyst, respectively.

This gave at room temperature a liquid polycarbonate polyol having the following characteristics:

| | | |
|---|---|---|
| Hydroxyl number (OHN): | 58.3 | mg KOH/g |
| Viscosity at 23° C., D: 16: | 3900 | mPas |
| Number-average molecular weight (Mₙ): | 1921 | g/mol |

### Example 3

Comparative Example, PU Dispersion

1530.0 g of a difunctional polyester polyol based on adipic acid and hexanediol (average molecular weight was 1700 g/mol, OHN=approximately 66 mg KOH/g solids) were heated to 65° C. Subsequently, at 65° C., 455.1 g of isophorone diisocyanate were added over the course of 5 minutes and then the mixture was stirred at 100° C. until the theoretical NCO value of 4.6% was reached. The finished prepolymer was dissolved at 50° C. with 2781 g of acetone and then a solution of 139.1 g of isophorone diamine and 247.2 g of acetone was metered in over the course of 10 minutes. Thereafter a solution of 46.0 g of diaminosulphonate, 4.80 g of hydrazine hydrate and 239.1 g of water was metered in over the course of 5 minutes. The subsequent stirring time was 15 minutes. Subsequently the batch was dispersed by addition of 3057 g of water over the course of 10 minutes. Then the solvent was removed by vacuum distillation to give a storage-stable PU dispersion having a solids content of 40.1% and an average particle size of 207 nm.

### Example 4

Comparative Example, PU Dispersion

144.5 g of Desmophen® C2200, 188.3 g of PolyTHF® 2000, 71.3 g of PolyTHF® 1000 and 13.5 g of Polyether LB 25 were heated to 70° C. Subsequently, at 70° C., a mixture of 45.2 g of hexamethylene diisocyanate and 59.8 g of isophorone diisocyanate was added over the course of 5 minutes and then the mixture was stirred at 105° C. until the theoretical NCO value was reached. The finished prepolymer was dissolved at 50° C. with 1040 g of acetone and then a solution of 1.8 g of hydrazine hydrate, 9.18 g of diaminosulphonate and 41.9 g of water was metered in over the course of 10 minutes. The subsequent stirring time was 10 minutes. The addition of a solution of 21.3 g of isophorone diamine and 106.8 g of water was followed by dispersion of the batch, by addition of 395 g of water over the course of 10 minutes. Then the solvent was removed by vacuum distillation to give a storage-stable dispersion having a solids content of 50.0% and an average particle size of 312 nm.

### Example 5

PU Dispersion (Inventive)

356.6 g of polycarbonate polyol from Example 1, 78.4 g of PolyTHF® 1000 and 14.9 g of Polyether LB 25 were heated to 70° C. Subsequently, at 70° C., a mixture of 49.7 g of hexamethylene diisocyanate and 65.8 g of isophorone diisocyanate was added over the course of 5 minutes and then the mixture was stirred at 105° C. until the theoretical NCO value was reached. The finished prepolymer was dissolved at 50° C. with 1150 g of acetone and then a solution of 2.0 g of hydrazine hydrate, 10.1 g of diaminosulphonate and 46.2 g of water was metered in over the course of 10 minutes. The subsequent stirring time was 10 minutes. The addition of a solution of 23.4 g of isophorone diamine and 117.4 g of water was followed by dispersion of the batch, by addition of 325.0 g of water over the course of 10 minutes. Then the solvent was removed by vacuum distillation to give a storage-stable dispersion having a solids content of 54.7% and an average particle size of 355 nm.

### Example 6

PU Dispersion (Inventive)

356.6 g of polycarbonate polyol from Example 2, 78.4 g of PolyTHF® 1000 and 14.9 g of Polyether LB 25 were heated to 70° C. Subsequently, at 70° C., a mixture of 49.7 g of hexamethylene diisocyanate and 65.8 g of isophorone diisocyanate was added over the course of 5 minutes and then the mixture was stirred at 105° C. until the theoretical NCO value was reached. The finished prepolymer was dissolved at 50° C. with 1150 g of acetone and then a solution of 2.0 g of hydrazine hydrate, 10.1 g of diaminosulphonate and 46.2 g of water was metered in over the course of 10 minutes. The subsequent stirring time was 10 minutes. The addition of a solution of 23.4 g of isophorone diamine and 117.4 g of water was followed by dispersion of the batch, by addition of 325.0 g of water over the course of 10 minutes. Then the solvent was removed by vacuum distillation to give a storage-stable dispersion having a solids content of 55.2% and an average particle size of 279 nm.

### Example 7

PU Dispersion (Comparative Example)

PTIHFPC=50% by weight, based on the sum of components I.2)

146.3 g of polycarbonate polyol from Example 1, 103.5 g of PolyTHF® 2000, 53.5 g of PolyTHF® 1000 and 10.1 g of Polyether LB 25 were heated to 70° C. Subsequently, at 70° C., a mixture of 33.9 g of hexamethylene diisocyanate and 44.8 g of isophorone diisocyanate was added over the course of 5 minutes and then the mixture was stirred at 105° C. until the theoretical NCO value was reached. The finished prepolymer was dissolved at 50° C. with 796 g of acetone and then a solution of 1.2 g of hydrazine hydrate, 8.7 g of diaminosulphonate and 36.72 g of water was metered in over the course of 10 minutes. The subsequent stirring time was 10 minutes. The addition of a solution of 15.9 g of isophorone diamine and 80.1 g of water was followed by dispersion of the batch, by addition of 497.0 g of water over the course of 15 minutes. Then the solvent was removed by vacuum distillation to give a storage-stable dispersion having a solids content of 40.0% and an average particle size of 387 nm.

### Example 8

PU Dispersion (Comparative Example)

Polyol I.2=45% by weight, based on the sum of components I); PTHF-PC=82% by weight, based on the sum of components I.2)

156.4 g of polycarbonate polyol from Example 1, 33.6 g of a difunctional polyether based on polypropylene oxide (average molecular weight 561 g/mol, OH number 200) and 50.8 g of Polyether LB 25 were heated to 70° C. Subsequently, at 70° C., a mixture of 51.3 g of hexamethylene diisocyanate and 67.8 g of isophorone diisocyanate was added over the course of 5 minutes and then the mixture was stirred at 105° C. until the theoretical NCO value was reached. The finished prepolymer was dissolved at 50° C. with 730 g of acetone and then a solution of 2.4 g of hydrazine hydrate, 43.8 g of diaminosulphonate and 166.6 g of water was metered in over the course of 10 minutes. The subsequent stirring time was 10 minutes. The addition of a solution of 33.6 g of isophorone diamine and 168.6 g of water was followed by dispersion of the batch, by addition of 262.0 g of water over the course of 15 minutes. Then the solvent was removed by vacuum distillation to give a storage-stable dispersion having a solids content of 39.0% and an average particle size of 456 nm.

The properties of PU dispersions are determined on free films produced as follows:

A film applicator consisting of two polished rolls which can be set an exact distance apart has a release paper inserted into it ahead of the back roll. The distance between the paper and the front roll is adjusted using a feeler gauge. This distance corresponds to the film thickness (wet) of the resulting coating, and can be adjusted to the desired add-on of each coat. Coating can also be carried out consecutively in two or more coats.

To apply the individual coats the products (aqueous formulations are adjusted beforehand to a viscosity of 4500 mPa s by addition of ammonia/polyacrylic acid) are poured onto the nip between the paper and the front roll, the release paper is pulled away vertically downwards, and the corresponding film is formed on the paper. Where two or more coats are to be applied, each individual coat is dried and the paper is reinserted.

The modulus at 100% elongation was determined in accordance with DIN 53504 on films>100 μm thick.

The average particle sizes (the figure reported is the number average) of the PU dispersions were determined by means of laser correlation spectroscopy (instrument: Malvern Zetasizer 1000, Malvern Instr. Limited).

TABLE 1

| | | | | | |
|---|---|---|---|---|---|
| Example 3 | Example 4 | | | Example 7 | Example 8 |
| comparative | comparative | Example 5 | Example 6 | comparative | comparative |

Initial values

| | | | | | | |
|---|---|---|---|---|---|---|
| 100% modulus | 2.0 | 2.2 | 2.2 | 1.9 | 1.1 | 4.2 |
| {MPa} | | | | | | |
| Tensile strength | 20.0 | 35.7 | 60.4 | 57.6 | 10.7 | 5.2 |
| {MPa} | | | | | | |
| Breaking | 980 | 1070 | 1660 | 1530 | 1800 | 440 |
| extension [%] | | | | | | |

After 24 h storage in water at 23° C.

| | | | | | | |
|---|---|---|---|---|---|---|
| Tensile strength | 12.5 | 11.1 | 14.6 | 13.7 | 0.5 | 1.1 |
| {MPa} | | | | | | |
| Breaking | 880 | 780 | 1180 | 1290 | 1050 | 930 |
| extension [%] | | | | | | |

After 4 weeks' storage under hydrolysis conditions*

| | | | | | | |
|---|---|---|---|---|---|---|
| Tensile strength | 5.3 | 28.8 | 36.5 | 32.8 | film has run | film has run |
| {MPa} | | | | | | |
| Breaking | 1100 | 970 | 1280 | 1150 | film has run | film has run |
| extension [%] | | | | | | |

After 10 weeks' storage under hydrolysis conditions*

| | | | | | | |
|---|---|---|---|---|---|---|
| Tensile strength | film has run | 31.5 | 39.0 | 36.9 | film has run | film has run |
| {MPa} | | | | | | |
| Breaking | film has run | 990 | 1350 | 1410 | film has run | film has run |
| extension [%] | | | | | | |

As is apparent from Table 1, the coatings produced from the PU dispersions of the invention (Example 5 and 6) combine comparable hardness with substantially higher stretchabilities and tensile strength in conjunction with comparable or better hydrolysis stabilities as compared with the coatings of the prior art (Comparative Example 3 and 4). Coatings comprising dispersions comprising polytetramethylene glycol-based polycarbonates outside the compositional range of the invention (Example 7 and 8) do not exhibit the aforementioned improvements.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane-polyurea dispersion comprising the synthesis components:
I.1) one or more polyisocyanates,
I.2) one or more polymeric polyols having molecular weights of 400 to 8000 g/mol, having a hydroxyl number of 22 to 400 mg KOH/g and an OH functionality of 1.5 to 6,
I.3) one or more compounds having molecular weights of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds, and
I.6) optionally one or more isocyanate-reactive, nonionically hydrophilicizing compounds,
wherein the polyol component I.2) contains 60% to 100% by weight of polytetramethylene glycol-based polycarbonate polyols, based on the total amount of component I.2) and the dispersion contains 60% to 90% by weight of the sum of components I.2), based on the total weight of the synthesis components.

2. An aqueous polyurethane-polyurea dispersion according to claim 1, wherein the polyol component I.2) contains 65% to 100% by weight of polytetramethylene glycol-based polycarbonate polyols, based on the total amount of component I.2).

3. An aqueous polyurethane-polyurea dispersion according to claim 1, wherein the polytetramethylene glycol-based polycarbonate polyols have a molecular weight Mn of 400 to 8000 g/mol and an OH functionality of 1.5 to 4.0.

4. An aqueous polyurethane-polyurea dispersion according to claim 1, wherein the polytetramethylene glycol-based polycarbonate polyols have a molecular weight of 600 to 3000 g/mol and an OH functionality of 1.8 to 3.0.

5. An aqueous polyurethane-polyurea dispersion according to claim 1, wherein component I.2) is a mixture of polytetramethylene glycol-based polycarbonate polyols with polytetramethylene glycol polyether polyols having a number-average molar weight of 600 to 3000 g/mol and an OH functionality of 1.9 to 2.2.

6. An aqueous polyurethane-polyurea dispersion according to claim 1, comprising 5% to 40% by weight of component I.1), 60% to 90% by weight of the sum of components I.2), 0.5% to 20% by weight of the sum of compounds I.3) and I.4), 0.1% to 5% by weight of component I.5), and 0% to 20% by weight of component I.6), wherein the sum of I.5 and I.6) is between 0.1% to 25% by weight and the sum of all the components add up to 100% by weight.

7. A process for preparing the aqueous polyurethane-polyurea dispersion according to claim 1, comprising:
a) reacting:
I.1) one or more polyisocyanates,
I.2) one or morepolymeric polyols having molecular weights of 400 to 8000 g/mol, having a hydroxyl number of 22 to 400 mg KOH/g and an OH functionality of 1.5 to 6,
I.3) one or more compounds having molecular weights of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds,
I.6) optionally one or more isocyanate-reactive, nonionically hydrophilicizing compounds
such that an isocyanate-functional prepolymer free of urea groups is prepared, the molar ratio of isocyanate groups to isocyanate-reactive groups being 1.0 to 3.5
b) dispersing the reaction products in water; and
c) before, during or after dispersing in water, subjecting the remaining isocyanate groups to amino-functional chain extension or chain termination, wherein the equivalent ratio of isocyanate-reactive groups of the compounds used for chain extension to free isocyanates groups of the prepolymer is between 40% to 150%.

8. Coating materials comprising the polyurethane-polyurea dispersion according to claim 1.

9. A process for producing coated substrates comprising applying a coating material according to claim 8 to a substrate.

10. The process according to claim 9, wherein the substrate is selected from the group consisting of textiles and leather.

11. Substrates coated with coating materials according to claim 8.
